(19) United States
(12) Patent Application Publication
(10) Pub. No.: US 2016/0070596 A1
(43) Pub. Date: Mar. 10, 2016

(54) Workflow Execution System and Method for Cloud Environment

(71) Applicant: P. ASHOK ANAND, Chennai (IN)

(72) Inventors: P. Ashok Anand, Chennai (IN); Giribabu Yerradla, Chennai (IN); Gowri Shankar, Chennai (IN)

(21) Appl. No.: 14/784,379

(22) PCT Filed: Apr. 15, 2014
(86) PCT No.: PCT/IN2014/000236

§ 371 Date: Oct. 14, 2015

(30) Foreign Application Priority Data
Apr. 15, 2013 (IN) 1685/CHE/2013

(51) Int. Cl. G06F 9/50

(52) U.S. Cl. CPC G06F 9/5005

(57) ABSTRACT

This application relates to a workflow execution system and method for processing and executing at least one node within a cloud environment. A process identity (ID) with respect to request message can be obtained to thereby identify a process definition from a deployment table of the workflow execution module. An instance with respect to the current process can be created for execution of the node of a workflow. An outgoing sequence flow with respect to the executing node can be obtained to thereby identify a target node identify (ID) with respect to the outgoing sequence flow of the node. A definition with respect to the executing node can be extracted from the process definition using the target node identify (ID) to thereby effectively execute the workflow within a cloud environment.

### TECHNICAL FIELD

Embodiments are generally related to data processing systems and methods. Embodiments are also related to cloud computing platforms and networks. Embodiments are additionally related to workflow execution systems and methods for cloud computing environment.

### BACKGROUND OF THE INVENTION

A workflow is a collection of nodes and sequence flow connecting nodes and their properties. The workflow information can be stored into a data structure in order to thereby retrieve the nodes efficiently and maintain the order of the nodes intact. A workflow engine interprets events, such as documents submitted to a server or due dates expiring, and acts on them according to defined computer processes. The actions may be anything from saving the document in a document management system to issuing new work by sending an e-mail to users or escalating overdue work items to management. A workflow engine facilitates the flow of information, tasks, and events. Workflow engines may also be referred to as a Workflow Orchestration Engines.

A workflow engine is a software system used to run a multitude of tasks. Each task is typically the invocation of an executable program. Such tasks can have precedence relationships between them. Thus, the workflow may be looked upon as a graph, where each node represents a task to be performed, and an edge represents a precedence relationship. In a majority of cases, the workflow task graph can be acyclic. Typically, users run a set of workflows at one go. In this set, users can create copies of a workflow for different inputs. Secondly, users can also create workflows by changing existing workflows slightly. As such, it would be a sub-optimal choice to consider each workflow as a separate entity. To minimize computation in the workflow set and take advantage of the common structure, it would be desirable to merge all of the workflow directed acyclic graphs (DAGs) into a single graph. An exemplary data structure that is used to store the workflow information is illustrated here below:

Workflow execution and optimization methods are well known in the art. Such prior art methods are extensively implemented in a wide range of workflow execution application. Such prior art workflow execution methods do not provide dynamic information processing and execution in a cloud computing environment. Also, prior art workflow execution may require larger computational power for processing their input, but may not be able to store inputs effectively, or such storing may be too expensive in performance or resources terms. Further, prior art workflow execution methods are unable to provide state of a process instance.

Based on the foregoing, it is believed that a need exists for an improved workflow execution system and method for cloud environment. A need also exists for an improved processes serializer, as described in greater detail herein.

### SUMMARY OF THE INVENTION

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved workflow execution for cloud networks.

It is another aspect of the disclosed embodiments to provide for an improved workflow execution system and method for cloud environment.

It is further aspect of the disclosed embodiments to provide for an improved process serializer for serializing/de-serializing the state of a process instance with in a cloud computing environment.

The aforementioned aspects and other objectives and advantages can now be achieved as described herein. A workflow execution system and method for processing and executing at least one node within a cloud environment, is described herein. A process identity (ID) with respect to request message can be obtained in order to thereby identify a process definition from a deployment table of the workflow execution module. An instance with respect to the current process can be created for execution of the node of a workflow. The node execution process may not alter the process definition. A new instance is always created to represent the execution of the node within the workflow. An outgoing sequence flow with respect to the executing node can be obtained in order to thereby identify a target node identity (ID) with respect to the outgoing sequence flow of the node. A definition with respect to the executing node can be extracted from the process definition using the target node identity (ID) in order to thereby effectively execute the workflow within a cloud environment.

The workflow execution system described herein effectively identifies the execution mode with respect to the node in the workflow and performs appropriate action on the node. If the node is undergoing a new execution, a start node is determined from the process definition and a new process instance is created with respect to the node. At least one process variable can be initialized with respect to the node with at least one input value. The “node start” logic with respect to the start node can be executed in order thereby consecutively execute “a node end” logic with respect to the node within the workflow. Similarly, if the node is undergoing a invocation of the serialized process, the node identity from the request message can be obtained in order to thereby obtain the node to be executing from the process definition. An instance of the process can be created and the state of the serialized instance can be restored in order to execute the “'node end” logic of the node.

The workflow execution system also includes a process serializer module in order to serialize/de-serialize the state of the process instance with respect to the node of the workflow. The process sterilizer module of the workflow execution system performs re-instantiating the state of the process and continues the execution of the node on receiving the event or on completion of user activity. The process serializer module receives a message from a queue in order to retrieve a thread from a pool of thread in order to handle the event.

The process serializer further identifies the event type in order to perform appropriate action on the thread selected from the message. The event data can be typically added into the registry in order to thereby persist the event data i.e, to update the status of the process. The event data can be modified in the registry in order to thereby update already persisted data. Similarly, the event data can be read in order to thereby delete the persistent data. The process can be further executed after restoring the state of the process in order to thereby effectively update the state of the process instance. Such a system and method can be effectively employed in a wide range of workflow monitoring and optimization environment in order to achieve greater execution rate and performance in the cloud environment.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a graphical representation of a workflow execution system for maximizing the operations of server/nodes within a cluster of a cloud network, in accordance with the disclosed embodiments;

FIG. 2 illustrates a high level flow chart of operations illustrating logical operational steps of a method for executing processes of the node within a cloud environment, in accordance with the disclosed embodiments; and

FIG. 3 illustrates a high level flow chart of operating illustrating logical operational steps of a method for serializing/de-serializing the state of a process instance using the serializer module, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

The embodiments now will be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

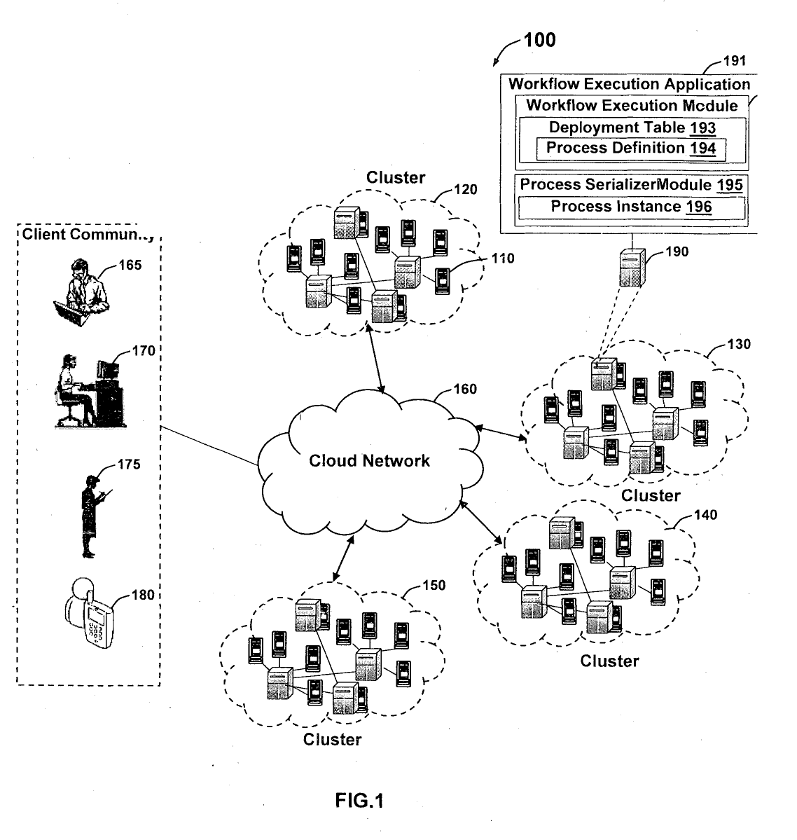

FIG. 1 illustrates a graphical representation of a workflow execution system 100 for maximizing the operations of server/nodes 110 within a cluster 120-150 of a cloud network 160, in accordance with the disclosed embodiments. The embodiments and the pictorial representations provided in FIG. 1, depicts a cloud computing network 160 connected to one or more clusters 120-150 and client computers 165-180 in which the present invention may be implemented. The system 100 contains the cloud network 160, which is the medium used to provide communications links between various devices and computers connected together within the system 100.

The clusters 120-150 described herein can be a parallel or distributed system that comprises a collection of interconnected computers/servers, such as server 110 that is used as a single, unified computing unit. Members of the cluster 120-150 are referred to as server/node 110. In general, clustering may be used for parallel processing or parallel computing to simultaneously use two or more processors to execute an application or program. Clustering is a popular strategy for implementing parallel processing applications because it allows system administrators to leverage already existing computers and workstations.

Clustering also provides for increased scalability by allowing new components to be added as the system load increases. In addition, clustering simplifies the management of groups of systems and their applications by allowing the system administrator to manage an entire group as a single system. Clustering may also be used to increase the fault tolerance of the network. If one server/node suffers an unexpected software or hardware failure, another clustered server/node may assume the operations of the failed server/node. Thus, if any hardware of software component in the system fails, the user might experience a performance penalty, but will not lose access to the service.

The clients 165-180 may be, for example, personal computers or network computers users accessing the server/nodes of the clusters for data, such as boot files, operating system images, and applications with respect to the clients. Note that the system 100 may include additional clusters, server/nodes, clients, and other devices not shown. In the depicted example, the cloud network can be an Internet with a worldwide collection of networks and gateways that use the Transmission Control Protocol/Internet Protocol (TCP/IP) suite of protocols to communicate with one another.

At the heart of the Internet is a backbone of high-speed data communication lines between major nodes or host computers, consisting of thousands of commercial, government, educational, and other computer systems that route data and messages. Of course, cloud network also may be implemented as a number of different types of networks, such as for example, an intranet, a local area network (LAN), or a wide area network (WAN). FIG. 1 is intended as an example, and not as an architectural limitation for embodiments of the present invention.

A workflow execution application 190 having a workflow execution application 191 is configured in association with the server/nodes 110 of the cluster 120-150 typically receives the message requests with respect to the customer/client 165-180 of the cluster 120-150 in the cloud network 160 in order to optimally assign the workflow to a server/node 110 within the cluster 120-150.

A process identity (ID) with respect to request message can be obtained in order to thereby identify a process definition 194 from a deployment table 193 of the workflow execution module 192. An instance with respect to the current process can be created for execution of the node 110 of the workflow. The node execution process may not alter the process definition 194. A new instance is always created to represent the execution of the node 110 within the workflow. An outgoing sequence flow with respect to the executing node 110 can be obtained in order to thereby identify a target node identity (ID) with respect to the outgoing sequence flow of the node 110. A definition with respect to the executing node 110 can be extracted from the process definition 194 using the target node identity (ID) in order to thereby effectively execute the workflow within a cloud environment.

The workflow execution system 100 described herein effectively identifies the execution mode 110 with respect to the node 110 in the workflow and performs appropriate action on the node 110. If the node 110 is undergoing a new execution, a start node is determined from the process definition and a new process instance is created with respect to the node. At least one process variable can be initialized with respect to the node with at least one input value. The “node start” logic with respect to the start node can be executed in order thereby consecutively execute “a node end” logic with respect to the node within the workflow. Similarly, if the node 110 is undergoing an invocation of the serialized process, the node identity from the request message can be obtained in order to thereby obtain the node 110 to be executing from the process definition 194. An instance of the process can be created and the state of the serialized instance can be restored in order to execute the “'node end” logic of the node 110.

The workflow execution system 100 also includes a process serializer module 195 in order to serialize/de-serialize the state of the process instance 196 with respect to the node 110 of the workflow. The process sterilizer module 195 of the workflow execution system 100 performs re-instantiating the state of the process and continues the execution of the node 110 on receiving the event or on completion of user activity. The process serializer module 195 receives a message from a queue in order to retrieve a thread from a pool of thread in order to handle the event.

The process serializer 195 further identifies the event type in order to perform appropriate action on the thread selected from the message. The event data can be typically added into the registry in order to thereby persist the event data i.e, to update the status of the process. The event data can be modified in the registry in order to thereby update already persisted data. Similarly, the event data can be read in order to thereby delete the persistent data. The process can be further executed after restoring the state of the process in order to thereby effectively update the state of the process instance 196.

The following discussion is intended to provide a brief, general description of suitable computing environments in which the system and method may be implemented. Although not required, the disclosed embodiments will be described in the general context of computer-executable instructions, such as program modules, being executed by a single computer. In most instances, a “module” constitutes a software application.

Generally, program modules include, but are not limited to routines, subroutines, software applications, programs, objects, components, data structures, etc., that perform particular tasks or implement particular abstract data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines, and an implementation, which is typically private (accessible only to that module) and which includes source code that actually implements the routines in the module. The term module may also simply refer to an application, such as a computer program designed to assist in the performance of a specific task, such as word processing, accounting, inventory management, etc.

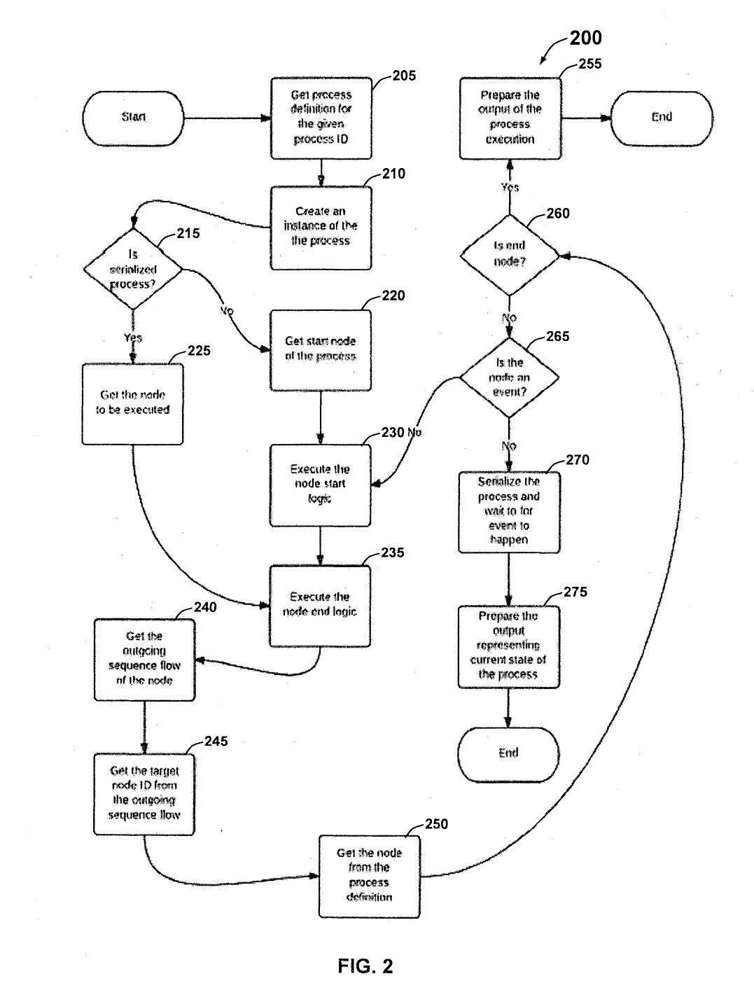

FIG. 2 illustrates a high level flow chart of operations illustrating logical operational steps of a method 200 for executing processes of the node 110 within a cloud environment 160, in accordance with the disclosed embodiments. Note that in FIGS. 1-3 identical or similar components are indicated with identical numerical. FIGS. 1-3 are intended as an example, and not as an architectural/procedural limitation with respect to particular embodiments. Such embodiments, however, are not limited to any particular application or any particular computing or data-processing environment. Instead, those skilled in the art will appreciate that the disclosed system and method may be advantageously applied to a variety of system and application software. Moreover, the present invention may be embodied on a variety of different computing platforms, including Macintosh, Windows, UNIX, LINUX, and the like. The following discussion is intended to provide a brief, general description of suitable computing environments in which the system and method may be implemented.

A process identity (ID) with respect to request message can be obtained in order to thereby identify the process definition 194 from the deployment table 193 of the workflow execution module 192, as illustrated in the block 205. An instance with respect to the current process can be created for execution of the node 110 of a workflow, as depicted at block 210. If the process is a serialized process, as illustrated at block 220, the node 110 that is to be executed can be obtained in order to thereby execute the node end logic, as illustrated at block 225 and 235. Otherwise, the start node of the process can be obtained in order to thereby execute the node start logic, as depicted at blocks 230 and 235. Further, the node end logic can be executed, as illustrated at block 230. An outgoing sequence flow with respect to the executing node can be obtained in order to thereby identify a target node identity (ID) with respect to the outgoing sequence flow of the node, as illustrated at block 240 and 245. The process definition 194 with respect to the executing node 110 can be extracted from the process definition 194 using the target node identity (ID) in order to thereby prepare the output of the process execution, as illustrated at block 255.If it is an end node, as depicted at block 265, the process execution can be terminated. Otherwise, the process can be serialized and awaited for the even to happen, as illustrated at block 270. Finally, the output representing the current status of the process can be generated in order to thereby effectively handle workflow execution in a wide range of cloud environments, as depicted at block 275.

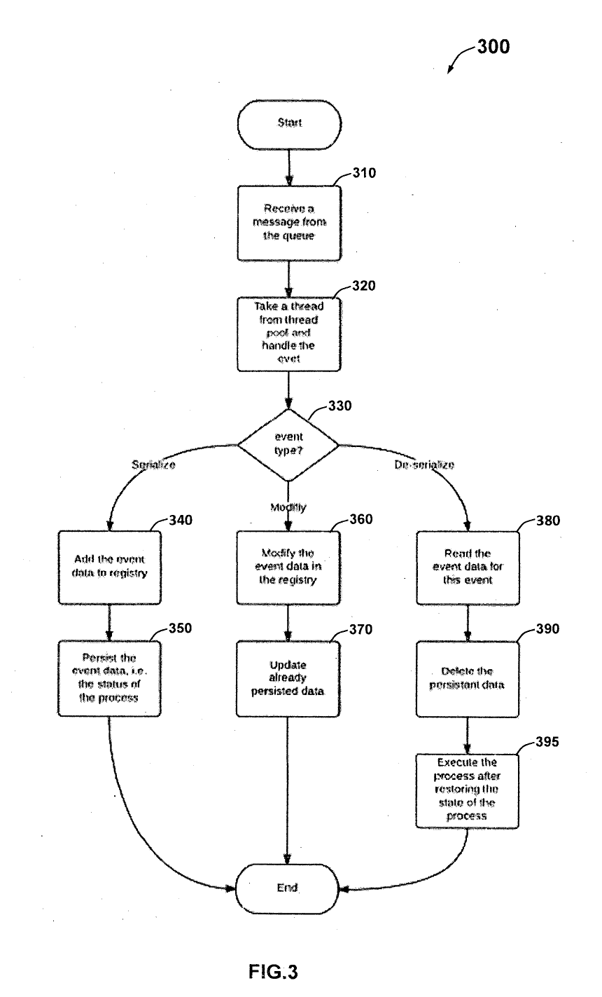

FIG. 3 illustrates a high level flow chart of operating illustrating logical operational steps of a method 300 for serializing/de-serializing the state of a process instance 196 using, the serializer module 195, in accordance with the disclosed embodiments. The process serializer module 195 effectively serialize/de-serialize the state of the process instance 196 with respect to the node 110 of the workflow. The process sterilizer module of the workflow execution system performs re-instantiating the state of the process and continues the execution of the node on receiving the event or on completion of user activity. A message can be received from the queue in order to retrieve a thread from a pool of thread in order to handle the event, as illustrated at block 310 and 320.

The process serializer further identifies the event type in order to perform appropriate action on the thread selected from the message, as depicted at block 330. If the event is a serialize event, the event data can be typically added into the registry in order to thereby persist the event data i.e, to update the status of the process, as illustrated at blocks 340 and 350. Similarly, if the event type is modify event, the event data can be modified in the registry in order to thereby update already persisted data, as illustrated at block 360 and 370.1f the event type is de-serialize event, the event data can be read in order to thereby delete the persistent data, as illustrated at block 380 and 390. The process can be further executed after restoring the state of the process in order to thereby effectively update the state of the process instance, as illustrated at block 395. Such a system and method can be effectively employed in a wide range of workflow monitoring and optimization environment in order to achieve greater execution rate and performance in the cloud environment.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

I/we claim:

1. A method for processing and executing at least one node within a cloud environment, comprising:
obtaining a process identity (ID) with respect to request a message in order to thereby identify a process definition from a deployment table of a workflow execution module;
creating an instance with respect to the current process for execution of the node of a workflow wherein the node execution process will alter the process definition and a new instance is always created to represent the execution of the node within the workflow;
obtaining an outgoing sequence flow with respect to the executing node in order to thereby identify a target node identity (ID) with respect to the outgoing sequence flow of the node; and
extracting a definition with respect to the executing node from the process definition using the target node identity (ID) in order to thereby effectively execute the workflow within the cloud environment.

2. The method of claim 1 wherein determining a start node from the process definition and creating a new process instance with respect to the node when the node is undergoing a new execution.

3. The method of claim 1further comprising 4
initializing at least one process variable with respect to the node with at least one input value and executing a “node start” logic with respect to the start node in order thereby consecutively execute “a node end” logic with respect to the node within the workflow;
obtaining the node identity from the request message if the node is undergoing an invocation of the serialized process in order to thereby obtain the node to be executing from the process definition; and
creating an instance of the process in order to thereby restoring the state of the serialized instance to execute the “'node end” logic of the node.

4. The method of claim 1 further comprising serializing/de-serializing the state of the process instance with respect to the node using a process serializer.

5. The method of claim 1 further comprising re-instantiating the state of the process and continuing the execution of the node using the process serializer on receiving the event or on completion of user activity wherein the process serializer receives a message from a queue in order to retrieve a thread from a pool of thread in order to handle the event.

6. The method of claim 1 further comprising identifying the event type using the process serializer in order to perform appropriate action on the that selected from the message.

7. The method of claim 1 further comprising
adding the event data into the registry in order to thereby persist the event data wherein the event data can be modified in the registry in order to thereby update already persisted data;
reading the event data in order to thereby delete the persistent data and executing the process after restoring the state of the process in order to thereby effectively update the state of the process instance.
